(19) United States
(12) Patent Application Publication
(10) Pub. No.: US 2014/0032924 A1
(43) Pub. Date: Jan. 30, 2014

(54) MEDIA ENCRYPTION BASED ON BIOMETRIC DATA

(71) Applicants: David M. Durham, Beaverton, OR (US); Xiaozhu Kang, Fremont, CA (US); Prashant Dewan, Hillsboro, OR (US); Men Long, Beaverton, OR (US); Karanvir S. Grewal, Hillsboro, OR (US)

(72) Inventors: David M. Durham, Beaverton, OR (US); Xiaozhu Kang, Fremont, CA (US); Prashant Dewan, Hillsboro, OR (US); Men Long, Beaverton, OR (US); Karanvir S. Grewal, Hillsboro, OR (US)

(21) Appl. No.: 13/562,046

(22) Filed: Jul. 30, 2012

(51) Int. Cl. G06F 21/00

(52) U.S. Cl. 713/186

(57) ABSTRACT

Embodiments of techniques and systems for biometric-data-based media encryption are described. In embodiments, an encryption key may be created for a recipient user based at least in part on biometric data of the recipient user. This encryption key may be maintained on a key maintenance component and used by a sharing user to encrypt a media file for access by the recipient user. One or more access policies associated with recipient user may be encrypted in the encrypted media file as well. In embodiments, the media file may be encrypted for use by multiple recipient users. When a recipient user desires to access the encrypted media file, a decryption key may be generated in real time based on contemporaneously captured biometric data and used to provide access to the encrypted media file. Other embodiments may be described and claimed.

### BACKGROUND

Online sharing of images, and other media files, continues to provide difficulties for content creators and consumers. In particular, it is difficult for users to share images online and feel confident that they remain secure. For example, many images shared in conventional techniques can be copied indefinitely by users. Additionally, many image-sharing sites must be trusted to not abuse the access they have to the images they host. In some techniques, images and other media files may be protected using passwords. However, these passwords may be hard to remember for users and can require manual setup and encoding for multiple users.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram illustrating an example biometric-data-based media-sharing system, in accordance with various embodiments.

FIG. 2 illustrates an example biometric-data-based media sharing process of the biometric-data-based media-sharing system, in accordance with various embodiments.

FIG. 3 illustrates an example encryption and decryption key generation process of the biometric-data-based media-sharing system, in accordance with various embodiments.

FIG. 4 illustrates an example biometric data capture process of the biometric-data-based media-sharing system, in accordance with various embodiments.

FIG. 5 illustrates an example media sharing process of the biometric-data-based media-sharing system, in accordance with various embodiments.

FIG. 6 illustrates an example media access process of the biometric-data-based media-sharing system, in accordance with various embodiments.

FIG. 7 illustrates an example computing environment suitable for practicing the disclosed embodiments, in accordance with various embodiments.

### DETAILED DESCRIPTION

Embodiments of techniques and systems for biometric-data-based media encryption are described herein. In embodiments, an encryption key may be created for a recipient user based at least in part on biometric data of the recipient user. This encryption key may be maintained on a key maintenance component and used by a sharing user to encrypt a media file for access by the recipient user. One or more access policies associated with recipient user may be encrypted in the encrypted media file as well In embodiments, the media file may be encrypted for use by multiple recipient users. When a recipient user desires to access the encrypted media file, a decryption key may be generated in real time based on contemporaneously captured biometric data and used to provide access to the encrypted media file. Other embodiments are also described.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C),

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As may be used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

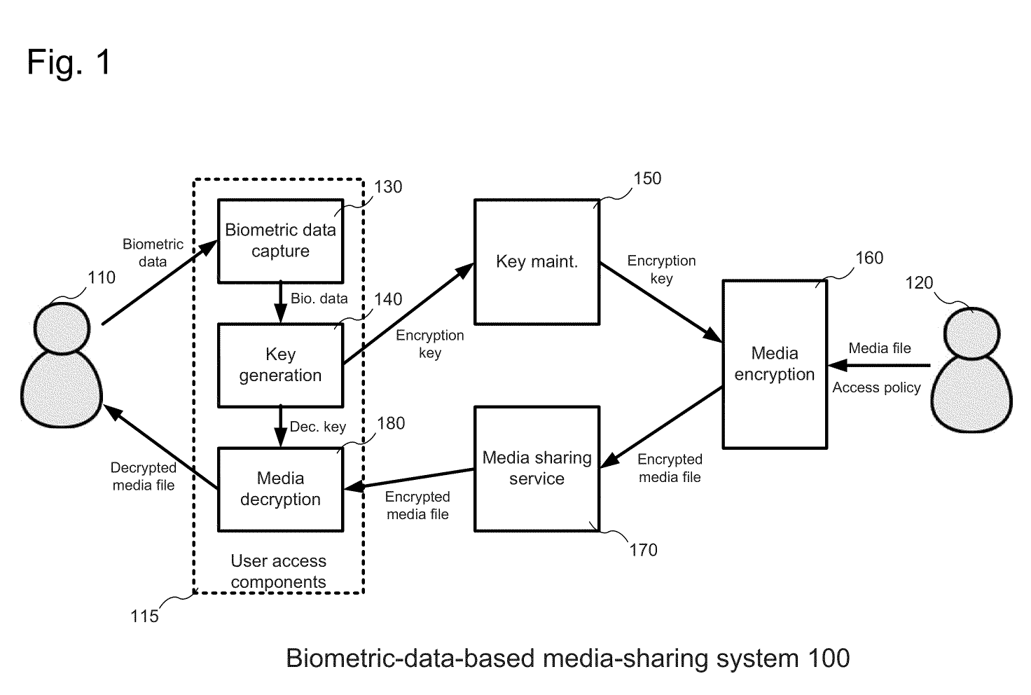

Referring now to FIG. 1, embodiments of a biometric-data-based media-sharing system 100 (“BMS 100”) are illustrated. In various embodiments, the BMS 100 may be configured to facilitate a sharing user 120 to share a media file with a recipient user 110. In various embodiments, the BMS 100 may facilitate the sharing of the media file using at least encryption keys that are based on biometric data obtained from the recipient user 110. By doing so, in various embodiments the BMS 100 may facilitate secured sharing of media files between the sharing user 120 and the recipient user 100.

In various embodiments, the recipient user, wanting to receive access to protected media, may perform a key-generation process where he or she has biometric data captured. The BMS 100 may then generate an encryption key based at least in part on the captured biometric data. Later, when the sharing user 120 wants to share a media file, he or she can use the biometric based generated encryption key to encrypt the media file. The encrypted media file may then be uploaded to a media sharing service, such as a media sharing website or social network. Later, when the recipient user 110 wishes to access the media file, he or she may, in various embodiments, allow the BMS 100 to capture biometric data contemporaneously with his or her attempt to access the encrypted media file, in various embodiments, a decryption key may then be generated based on this contemporaneously captured biometric data and used to decrypt the media file. In various embodiments, the contemporaneous capture of biometric data and generation of the decryption key may allow the recipient user to access the protected media while lessening the need for memorizing or storing passwords. In various embodiments, once used, the decryption key may be discarded.

In alternate embodiments, the sharing user 120 may encrypt the media file for access by multiple recipient users 110, using one encryption key that is in turn encrypted into multiple versions using corresponding biometric encryption keys of the recipient users 110. Such an encrypted media file may further include per-user access policies.

In various embodiments, regardless whether the encrypted media file is for single or multiple users, the BMS 100 may include user access components 115, which may be configured to be operated on a computing device accessed by or under control of a recipient user 100. In various embodiments, the user access components 115 may include one or more components configured to operate in software and/or hardware in order to facilitate access of shared media by the recipient user 110 based on biometric data of the recipient user 110.

In one example, the user access components 115 may include a biometric data capture component 130 that may be configured to capture biometric data from a recipient user 110. In various embodiments, the biometric data capture component may be configured to capture biometric data from an image of a recipient user 110. For example, in various embodiments, the biometric data capture component 130 may be configured to receive (or cause to be obtained) an image of a recipient user 110's face. The biometric data capture component 130 may then, in various embodiments extract biometric feature data from the image, such as the size, location, and/or orientation of various facial features. In another embodiment, the biometric data capture component 130 may be configured to receive (or cause to be obtained) fingerprint data from a recipient user 110, various embodiments, the biometric data capture component 130 may then provide this biometric data to other components of the user access components 115 of the BMS 100 to facilitate sharing of media files.

In various embodiments, a key generation component 140 may be configured to receive biometric data from the biometric data capture component 130 and use the biometric data to generate encryption and/or decryption keys for use by the BMS 100 in facilitating sharing of media files. In various embodiments, the key generation component 140 may generate one or more private/public key pairs based on biometric data obtained from the biometric data capture component 130. In various embodiments, the key generation component 140 may be configured to determine if the key generation component 140 has received sufficient biometric data from the biometric data capture component 130. In some embodiments, if the key generation component 140 has not received sufficient biometric data, the key generation component 140 may request additional biometric data from the biometric data capture component before generating public/private key pairs. In some embodiments, private/public key pairs may be generated based on techniques developed by Rivest, Shamir and Ademan, also known as “RSA” techniques. In other embodiments, other key generation techniques may be used. In various embodiments, the key generation component 140 may be configured to provide the public key of the private/public key pair to other components be used for encryption and/or to use the private key of the private/public key pair as a decryption key. In various embodiments, however, the key generation component 140 may also be configured to not release the private key of the private/public key pair to users in order to protect the key. In some embodiments, the key generation component 140 may be configured to keep the private key secret even from the recipient user 110. In various embodiments, one or more symmetric keys may be generated by the key generation component 140 instead of public/private key pairs.

In various embodiments, the key generation component 140 may be configured to send an encryption key associated with the recipient user 110 to a key maintenance component 150. In various embodiments, the key generation component 140 may be configured to send the public key of a private/public key pair to the key maintenance component 150 as the encryption key. In various embodiments, the key generation component 140 may be configured to send only the public key of the private/public key pair to the key maintenance component 150, avoiding knowledge of the private key by the key maintenance component 150. In various embodiments, the key maintenance component 150 may include, for example, a server, database, and/or other storage to store the received encryption key and to provide it for later use, such as when the sharing user 120 seeks to share a media file. In various embodiments, the key maintenance component 150 may be configured to maintain and provide multiple encryption keys to sharing user 120 for multiple recipient users 110. In some embodiments, the key maintenance component 150 may be associated with a media sharing service, such as the illustrated media sharing service 170. Particular embodiments of the media sharing service 170 are described below.

In various embodiments, a media encryption component 160 may be configured to be operated under control of the sharing user 120 to encrypt media files for protected access by the recipient user 110. Thus, in various embodiments, the media encryption component 160 may be configured to obtain an encryption key associated with the recipient user 110 from the key maintenance component 150. In various embodiments, the media encryption component 160 may also be configured to receive a media file for encryption. In various embodiments, the received media file may include one or more of, for example, an image, an audio file, a video file, a MIDI file, a PDF, and/or other types of media files. In various embodiments, the media encryption component 160 may also be configured to receive one or more access policies associated with the recipient user 110.

In various embodiments, as described earlier, the media encryption component 160 may be configured to encrypt a media file such that it may be accessed by multiple recipient users 110. In various embodiments, the media encryption component 160 may be configured to include access policies for multiple recipient users 110 in the media file. In various embodiments, the media encryption module 160 may be configured to encrypt the media file received from the sharing user 120 using a (user agnostic) symmetric media encryption key. The media encryption component 160 may be configured to then encrypt this symmetric media encryption key and include the symmetric media encryption key, in encrypted form, in the encrypted media file for decryption by the recipient user 110. In various embodiments, different encrypted versions of the symmetric media encryption key may be generated using the encryption keys of the recipient users 110 received from the key maintenance component 150. In various embodiments, in order to provide multiple recipient users 110 with access to a media file, the media encryption component 160 may encrypt the symmetric media encryption key multiple times with multiple encryption keys obtained from the key maintenance component 150. Thus, any one recipient user 110 may, if he or she can provide the correct biometric-data-based decryption key, decrypt and recover the symmetric media encryption key and thus be able to obtain access to the media file, using the recovered symmetric media encryption key. In various embodiments, this access may be mediated by access policies associated with the user that are included in the encrypted media file.

In various embodiments, after encrypting the media file, the sharing user 120 may share the encrypted media file on a media sharing service 170. In various embodiments, the media sharing service 170 may include a social network; in other embodiments, the media sharing service 170 may include a media sharing website, or an other website. In various embodiments, the sharing user 120 may cause the media encryption component 160 to send the encrypted media file to the media sharing service 170. In various embodiments, the sharing user 120 may obtain the encrypted media file from the media encryption component 160 and may then send the encrypted media file to the media sharing service 170 themselves.

As discussed above, in various embodiments, the recipient user 110 may later desire access to the encrypted media file. The recipient user 110 may then cause the media decryption component 180 of the user access components 115 to obtain the encrypted media file. In various embodiments, the media decryption component 180 may directly obtain the encrypted media file from the media sharing service. In other embodiments, the recipient user 110 may obtain the encrypted media file from the media sharing service 170 and may provide the encrypted media file to the media decryption component themselves. In yet other embodiments, the recipient user 110 may obtain the encrypted media file via another conduit, such as by being sent the encrypted media file directly from the sharing user 120.

In various embodiments, the media decryption component 180 may be configured to decrypt the received encrypted media file, using a contemporaneously obtained biometric based decryption key. In various embodiments, the media decryption component 180 may contemporaneously obtain the biometric-based decryption key from the key generation component 140 of the user access components 115. In various embodiments, the key generation component 140 may be configured to generate, in real-time, a decryption key based at least in part on contemporaneously captured biometric data of the recipient user 110. In various embodiments, the biometric capture component 130 may be configured to perform this contemporaneous capture of biometric data and to provide the captured biometric data to the key generation component 140 for real-time generation of the biometric-based decryption key. In various embodiments, the media decryption component 180 may also be configured to check one or more access policies included in the received encrypted media file to determine if the recipient user may access media encrypted in the encrypted media file. In various embodiments, the media decryption component 180 may be configured to allow or deny particular requested accesses to the encrypted media file by the recipient user 110 based on the access policies. The media decryption component 180 may thus, in various embodiments, be configured to provide a decrypted media file to the recipient user 110 after decrypting the encrypted media file.

In various embodiments, user access components 115 may be provided to corresponding computing devices (not shown) of recipient users 110. In some embodiments, user access components 115 may be provided to a shared computing device (not shown) for use by multiple recipient users 110. In various embodiments, both single or multi-user arrangements may be provided. While the foregoing embodiments have been described with the encryption keys and media files being provided to the sharing user 120 and recipient users 110 through key maintenance service 150 and media sharing service 170 respectively, in alternate embodiments, the encryption keys and/or the media files may be exchanged between the sharing user 120 and the recipient users 110 directly,

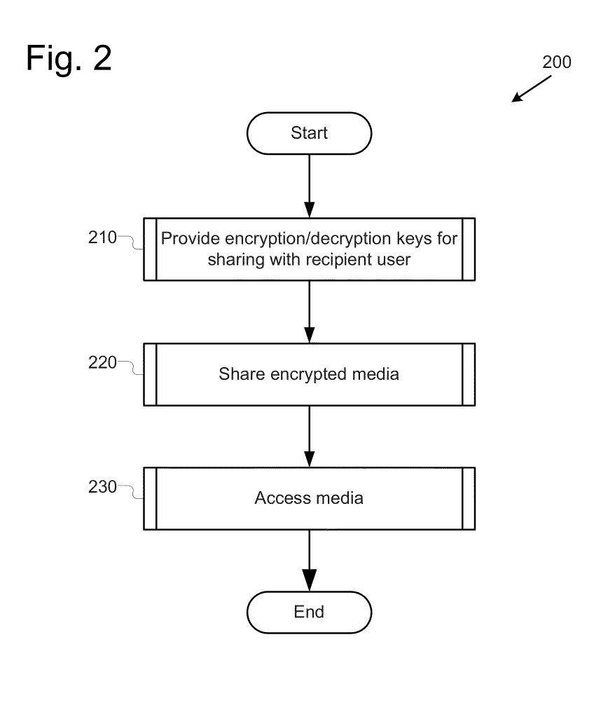

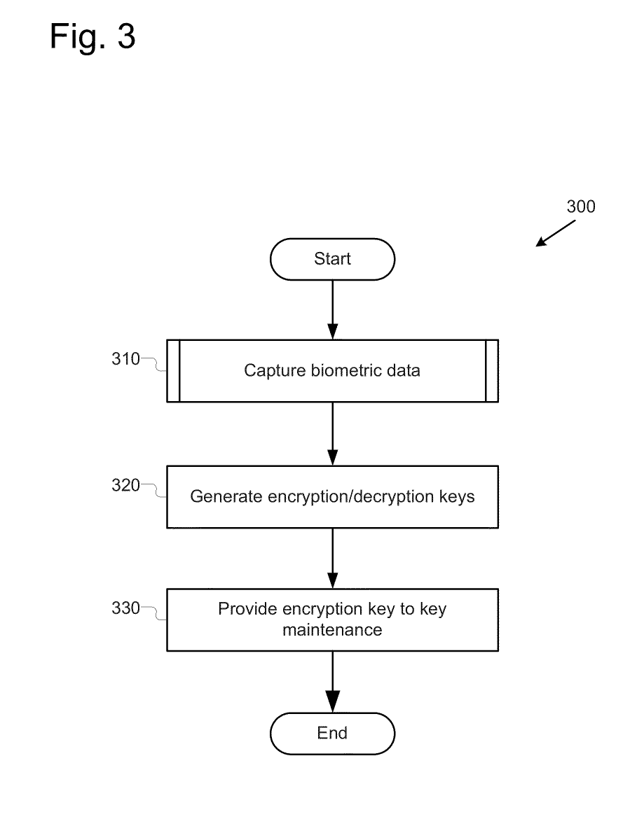

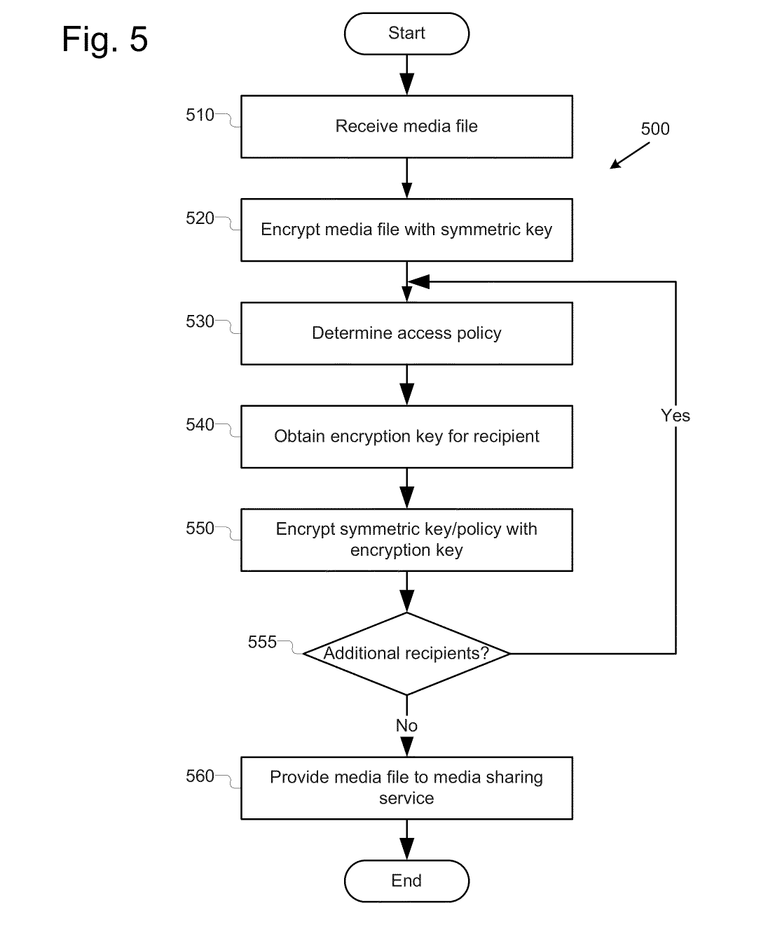

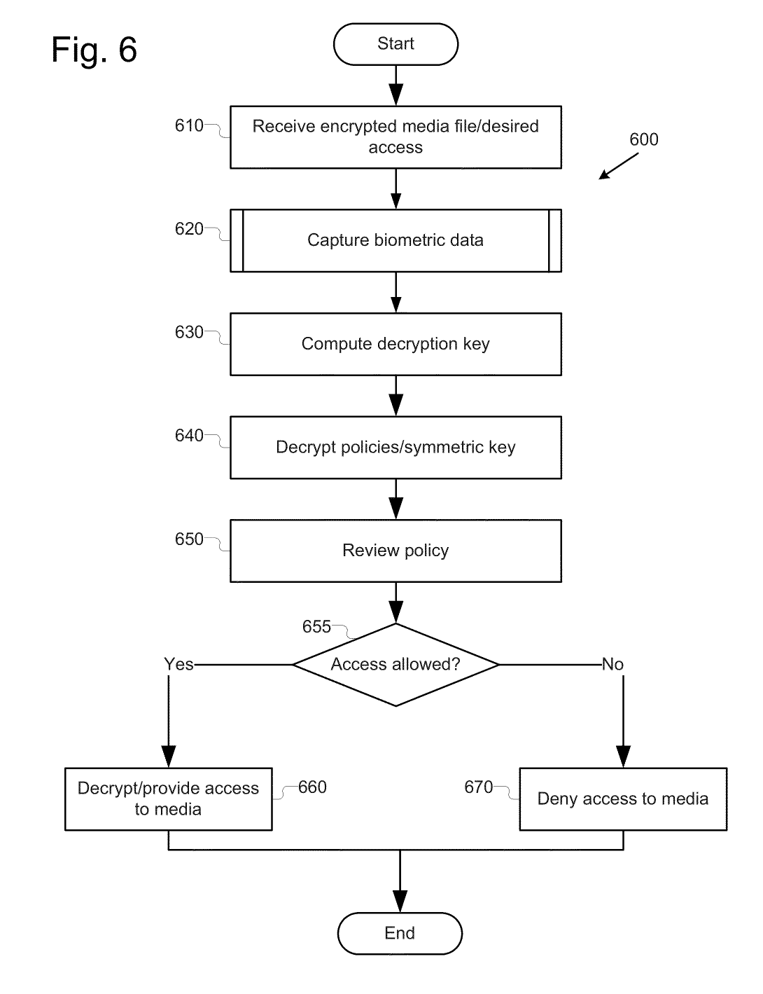

FIG. 2 illustrates an example biometric-data-based media sharing process 200 of the biometric-data-based media-sharing system, in accordance with various embodiments. It may be recognized that, while the operations of process 200 are arranged in a particular order and illustrated once each, in various embodiments, one or more of the operations may be repeated, omitted, or performed out of order. The process may begin at operation 210, where, in various embodiments, the BMS 100 may facilitate generation of encryption and/or decryption keys for sharing media files with the recipient user 110. Particular embodiments of operation 210 are described below with reference to process 300 of FIG. 3. Next, at operation 220, the sharing user 120 may, in various embodiments, share encrypted media, such as with the recipient user 110. Particular embodiments of operation 220 are described below with reference to process 500 of FIG. 5. Next, at operation 230 the recipient user may, in various embodiments, attempt to access the shared encrypted media. Particular embodiments of operation 230 are described below with reference to process 600 of FIG. 6. The process may then end.

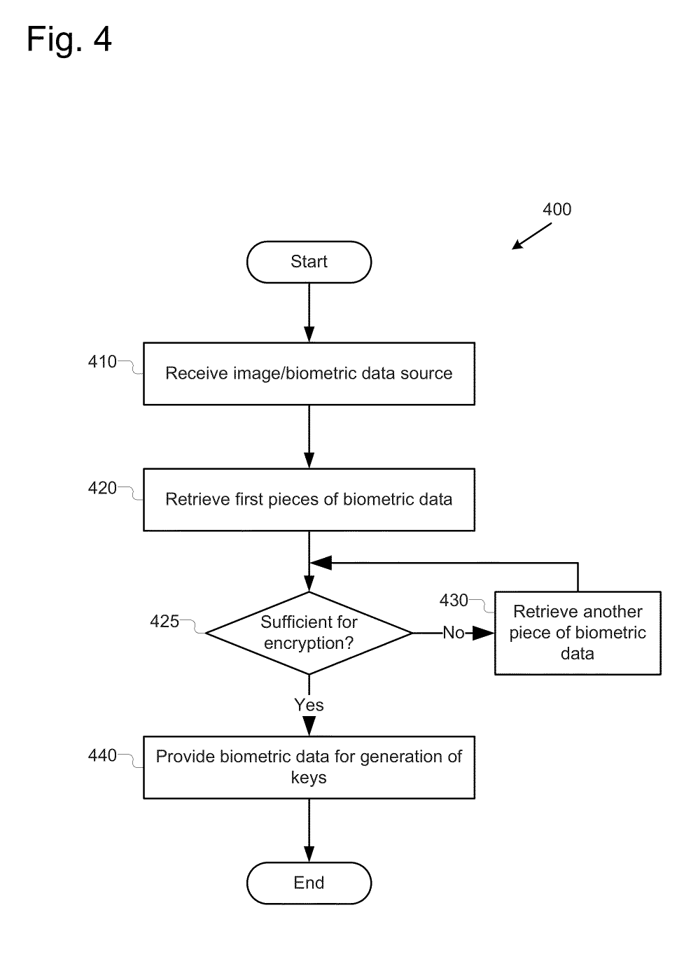

FIG. 3 illustrates an example encryption and/or decryption key generation process 300 of the biometric-data-based media-sharing system, in accordance with various embodiments. In various embodiments, process 300 may include one or more embodiments of operation 210 of process 200. It may be recognized that, white the operations of process 300 are arranged in a particular order and illustrated once each, in various embodiments, one or more of the operations may be repeated, omitted, or performed out of order. The process may begin at operation 310, where, in various embodiments, the biometric data capture component 130 may capture biometric data from the recipient user 110 to be used to generate encryption and decryption keys. Particular embodiments of operation 310 are described below with reference to process 400 of FIG. 4.

Next, at operation 320, the key generation component 140 may generate encryption and/or decryption keys based at least in part on the biometric data captured at operation 310. In various embodiments, the key generation component 140 may generate a private/public key pair at operation 310. In some embodiments, the private/public key pair may be generated at operation 320 using RSA techniques, as described above. In other embodiments, the key generation component 140 may generate a symmetric key rather than a private/public key pair, or other types of encryption and/or decryption keys. In various embodiments where a private/public key pair is generated, the public key may be used as the encryption key, and/or the private key may be used as the decryption key. Next, at operation 330, the key generation component 140 may provide the encryption key generated at operation 320 to the key maintenance component 150. The process may then end.

FIG. 4 illustrates an example biometric data capture process 400 of the biometric-data-based media-sharing system, in accordance with various embodiments. In various embodiments, process 400 may include one or more embodiments of operation 310 of process 300. It may be recognized that, white the operations of process 400 are arranged in a particular order and illustrated once each, in various embodiments, one or more of the operations may be repeated, omitted, or performed out of order. The process may begin at operation 410, where the biometric data capture component 130 may receive a biometric data source. In some embodiments, the biometric data source may include an image of the recipient user 110. For example, in such an embodiment, the biometric data capture component 130 may direct a camera to capture an image of the recipient user. In other embodiments, the biometric data source may include a different source, such as, for example, a fingerprint image, a retinal image, an iris image, video of movement of the user, a silhouette, etc.

Next, at operation 420, the biometric data capture component 130 may retrieve first pieces of biometric data from the received biometric data source. In various embodiments, the types of biometric data retrieved may be based, at least in part, on the type of the received biometric data source. For example, in some embodiments, when the biometric data source includes an image of a face, the pieces of biometric data may include data representing size, orientation, spacing, and/or location of one or more facial features which may be identified in the image. In another example, in some embodiments, when the biometric data source includes a fingerprint image, the pieces of biometric data may include data representing size, orientation, spacing, and/or location of one or more fingerprint ridge features which may be identified in the image.

Next, at decision operation 425, the biometric data capture component 130 may determine if there are sufficient pieces of biometric data retrieved to generate encryption and/or decryption keys. In various embodiments, the biometric data capture component 130 may communicate with the key generation component 140 in order to determine if sufficient pieces of biometric data have been received, if sufficient pieces have not been retrieved, then at operation 430, an additional piece of biometric data may be retrieved and the biometric data capture component may return to decision operation 425 to determine if there are now sufficient pieces of biometric data retrieved to generate encryption and/or decryption keys. However, if sufficient pieces have been retrieved, then, in various embodiments, at operation 440, the pieces of biometric data may be provided for key generation. In various embodiments, the pieces may thus be stored for retrieval by the key generation component 140 or may be provided directly to the key generation component 140. The process may then end.

FIG. 5 illustrates an example media sharing process 500 of the biometric-data-based media-sharing system, in accordance with various embodiments. In various embodiments, process 500 may include one or more embodiments of operation 220 of process 200. It may be recognized that, while the operations of process 500 are arranged in a particular order and illustrated once each, in various embodiments, one or more of the operations may be repeated, omitted, or performed out of order. The process may begin at operation 510, where the media encryption component 160 may receive a media file to be encrypted, such as from the sharing user 120. As discussed above, in various embodiments, the received media file may include one or more of, for example, an image, an audio file, a video file, a MIDI file, a PDF, and/or other types of media files. Next, at operation 520, the media encryption component 160 may encrypt the received media file with a symmetric encryption key to create encrypted media data. In various embodiments, the symmetric encryption key may or may not be associated with one or more of the sharing user 120, the received media file, and/or the receiving user 110.

Next, at operation 530 the media encryption component 160 may determine an access policy for the media file after encryption. In various embodiments, the access policy may be associated with one or more of, for example: the received media file, the sharing user 120, the receiving user 110, the type of media being encrypted, rights provided by a creator of the media, and/or other considerations. In various embodiments, the access policy may direct access for one or more of, for example, viewing the media, listening to the media, sharing the media, storing the media, copying the media, editing the media, etc.

At operation 540, the media encryption component 160 may then obtain an encryption key associated with the recipient user 110. As discussed above, in various embodiments, the encryption key may be a public key of a private/public key pair generated at operation 320 of process 300. In various embodiments, the encryption key may be obtained from the key maintenance component 150. Next, at operation 550, in various embodiments the media encryption component 150 may encrypt the symmetric encryption key used to encrypt the media file at operation 520 with the encryption key obtained from the key maintenance component 150. Additionally, in various embodiments, at operation 550 the media encryption component 150 may encrypt the access policy for the recipient user 110 with the encryption key obtained from the key maintenance component 150. Thus, the media encryption component 160 may generate encrypted metadata, in particular the encrypted symmetric media encryption key and the encrypted access policies, which may be used to decrypt the encrypted media data. This encrypted metadata may then be included in the encrypted media file for provisioning to the media sharing service 170. In various embodiments, instead of encrypting the media file with the symmetric media encryption key and encrypting the symmetric media encryption key with the encryption key received from the key maintenance component 150, the media encryption component 160 may encrypt the media file and/or the access policy/policies directly with the encryption key received from the key maintenance component 150.

Next, at decision operation 555, the media encryption component 160 may determine whether there are additional recipient users 110 with which the sharing user 120 wishes to share the received media file. If so, the process may repeat at operation 530. If not, then at operation 560, the media encryption component 160 may provide the encrypted media file to the media sharing service 170 for later sharing with the recipient user 110. In other embodiments, the media encryption component 160 may provide the encrypted media file to another component, such as a storage device, or may provide the encrypted media file directly to the recipient user 110. In some embodiments, the media encryption component may modify a form of the encrypted media file before providing it. For example, the encrypted media file may be printed as a photo in an encoded form which may be unintelligible to the recipient user without decryption. This form may allow the recipient user to scan the printed photo into an encrypted file and then access the encrypted media file such as described herein. The process may then end.

FIG. 6 illustrates an example media access process 600 of the biometric-data-based media-sharing system, in accordance with various embodiments. In various embodiments, process 600 may include one or more embodiments of operation 230 of process 200. It may be recognized that, while the operations of process 600 are arranged in a particular order and illustrated once each, in various embodiments, one or more of the operations may be repeated, omitted, or performed out of order. The process may begin at operation 610, where the media decryption component 180 of the user access components 115 may receive the encrypted media file. In some embodiments, at operation 610, the encrypted media file may be converted from a different form (e.g., scanning the printed encoded photo described above) in order to receive the encrypted media file. In various embodiments, the media decryption component 180 may also receive a type of access (such as viewing, editing, storing, etc.) desired by the recipient user 110 at operation 610. Next, at operation 620, the biometric data capture component 130 may contemporaneously capture biometric data from the recipient user 110 to use in generating in real-time a decryption key. Particular embodiments of operation 620 are described above with reference to process 400 of FIG. 4.

Next, at operation 630, the key generation component 140 may compute a decryption key using the captured biometric data, various embodiments, the key generation component 140 may generate a private/public key pair at operation 630 and use the private key as the decryption key. In some embodiments, the private/public key pair may be generated at operation 630 using RSA techniques, as described above. In various embodiments, the private key generated at operation 630 is identical to the private key generated at operation 320 of process 300.

Next, at operation 640, the media decryption component 180 may decrypt one or more access policies and/or a symmetric media encryption key using the decryption key generated at operation 630. At operation 650, in various embodiments, the decrypted policy may be reviewed to determine if the access requested by the recipient user 110 is permitted according to the one or more decrypted access policies. At operation 655, in various embodiments, the media decryption component may determine whether the requested access is allowed. If the access is allowed, then at operation 660, the media decryption component 180 may decrypt the media data in the encrypted media file and provide access to the media. If not, then at operation 670, the media decryption component may deny access to the media. In other embodiments, where media data is encrypted directly with the encryption key received from the key maintenance component 150, then at operation 640 the media data may be decrypted using the decryption key determined at operation 630. In such embodiments, the media decryption component 180 may still determine if access is allowed and provide selective access at operations 650, 655, 660, and 670. The process may then end. In various embodiments, as described earlier, once used, the decryption key may be discarded.

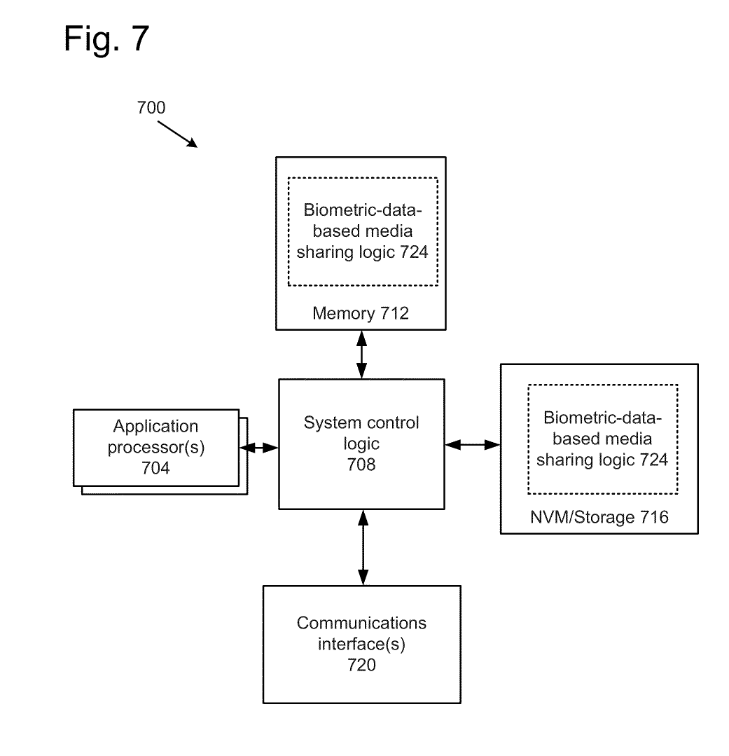

FIG. 7 illustrates, for one embodiment, an example computing device 700 suitable for practicing embodiments of the present disclosure. As illustrated, example computing device 700 may include control logic 708 coupled to at least one of the processor(s) 704, system memory 712 coupled to system control logic 708, non-volatile memory (NVM)/storage 716 coupled to system control logic 708, and one or more communications interface(s) 720 coupled to system control logic 708. In various embodiments, the one or more processors 704 may be a processor core.

System control logic 708 for one embodiment may include any suitable interface controllers to provide for any suitable interface to at least one of the processor(s) 704 and/or to any suitable device or component in communication with system control logic 708. System control logic 708 may also interoperate with a display 706 for display of information, such as to as user. In various embodiments, the display may include one of various display formats and forms, such as, for example, liquid-crystal displays, cathode-ray tube displays, and e-ink displays. In various embodiments, the display may include a touch screen.

System control logic 708 for one embodiment may include one or more memory controller(s) to provide an interface to system memory 712. System memory 712 may be used to load and store data and/or instructions, for example, for system 700. In one embodiment, system memory 712 may include any suitable volatile memory, such as suitable dynamic random access memory (“DRAM”), for example.

System control logic 708, in one embodiment, may include one or more input/output (“I/O”) controller(s) to provide an interface to NVM/storage 716 and communications interface(s) 720.

NVM/storage 716 may be used to store data and/or instructions, for example. NVM/storage 716 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example,

The NVM/storage 716 may include a storage resource physically part of a device on which the system 700 is installed or it may be accessible by, but not necessarily a part of, the device. For example, the NVM/storage 716 may be accessed over a network via the communications interface(s) 720.

System memory 712, NVM/storage 716, and system control logic 708 may include, in particular, temporal and persistent copies of biometric-data-based media sharing logic 724. The biometric-data-based media sharing logic 724 may include instructions that when executed by at least one of the processor(s) 704 result in the system 700 practicing one or more aspects of the user access components 115, key maintenance service 150, and/or media sharing service 170, described above. Communications interface(s) 720 may provide an interface for system 700 to communicate over one or more network(s) and/or with any other suitable device. Communications interface(s) 720 may include any suitable hardware and/or firmware, such as a network adapter, one or more antennas, a wireless interface 722, and so forth. In various embodiments, communication interface(s) 720 may include an interface for system 700 to use NFC, optical communications (e.g., barcodes), BlueTooth or other similar technologies to communicate directly (e.g., without an intermediary) with another device. In various embodiments, the wireless interface 722 may interoperate with radio communications technologies such as, for example, WCDMA, GSM, LTE, and the like.

Depending on whether computing device 700 is employed to host user access components 115, key maintenance service 150, and/or media sharing service 170, the capabilities and/or performance characteristics of processors 704, memory 712, and so forth may vary. In various embodiments, when used to host user access components 115, computing device 700 may be, but not limited to, a smartphone, a computing tablet, a ultrabook, e-reader, a laptop computer, a desktop computer, a set-top box, a game console, or a server. In various embodiments, when used to host key maintenance service 150 and/or media sharing service 170, computing device 700 may be, but not limited to, one or more servers known in the art.

For one embodiment, at least one of the processor(s) 704 may be packaged together with system control logic 708 and/or biometric-data-based media sharing logic 724. For one embodiment, at least one of the processor(s) 704 may be packaged together with system control logic 708 and/or biometric-data-based media sharing logic 724 to form a System in Package (“SiP”). For one embodiment, at least one of the processor(s) 704 may be integrated on the same die with system control logic 708 and/or biometric-data-based media sharing logic 724. For one embodiment, at least one of the processor(s) 704 may be integrated on the same die with system control logic 708 and/or biometric-data-based media sharing logic 724 to form a System on Chip (“SoC”).

The following paragraphs describe examples of various embodiments. In various embodiments, an apparatus for decrypting an encrypted media file may include one or more computer processors. The apparatus my also include a decryption key generation component configured to be operated by the one or more computer processors. The decryption key generation component may be configured to receive a request for a decryption key to decrypt an encrypted media file. The request may be generated in response to a user's request to access the encrypted media file. The media file may be encrypted using an encryption key generated based on previously provided biometric data of the user. The decryption key generation component may also be configured to generate, in response to the request, a decryption key based at least in part on real-time contemporaneously captured biometric data of the user. The decryption key generation component may also be configured to provide the decryption key for use to decrypt the encrypted media file.

In various embodiments, the apparatus may further include a media decryption component configured to be operated by the one or more computer processors to decrypt the encrypted media file using the provided decryption key. In various embodiments, the decryption key and encryption keys may form a private/public key pair.

In various embodiments, the apparatus may further include a biometric data capture component configured to capture biometric data of the user. In various embodiments, the biometric data capture component may include an image capture component. In various embodiments, the image capture component may be configured to be operated to capture biometric data from an image of the user's face. In various embodiments, the biometric data capture component may include a fingerprint capture component.

In various embodiments, an apparatus for decrypting an encrypted media file may include one or more computer processors. The apparatus may include a media encryption component configured to be operated by the one or more computer processors to obtain an encryption key generated based on previously provided biometric data of a user. The media encryption component may also be configured to encrypt the media file to produce an encrypted media file such that the encrypted media file may be decrypted using a decryption key generated based on contemporaneously captured biometric data of the user. The media encryption component may also be configured to provision the encrypted media file to be accessed by the user.

In various embodiments, the media encryption key may encrypt the media file through encryption of the media data using a symmetric media encryption key, encryption of the symmetric media encryption key using a public encryption key that is part of a public/private key pair generated based on previously provided biometric data of the user, and inclusion of the encrypted symmetric media encryption key in the encrypted media file. In various embodiments, the media encryption key may encrypt the media file through encryption of an access policy associated with the user using a public encryption key that is part of a public/private key pair generated based on previously provided biometric data of the user and inclusion of the access policy associated with the user in the encrypted media file, in various embodiments, the media encryption key may obtain an encryption key from a key maintenance component.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1. One or more non-transitory computer-readable media comprising instructions stored thereon that are configured to cause a computing device, in response to execution of the instructions by the computing device, to:
receive a request for a decryption key to decrypt an encrypted media file, wherein the request is generated in response to a user's request to access the encrypted media file, and wherein the media file is encrypted using a public key of a public-private key pair generated based on previously provided biometric data of the user; and
generate, in response to the request, the decryption key based at least in part on real-time contemporaneously captured biometric data of the user, wherein data about the private key of the public-private key pair is not available to the computing device; and
provide the decryption key for use to decrypt the encrypted media file.

2. The one or more non-transitory computer readable media of claim 1, wherein the instructions are further configured to cause the computer device, in response to execution, to decrypt the encrypted media file using the provided decryption key.

3. The one or more non-transitory computer readable media of claim 1, wherein the instructions are further configured to cause the computer device, in response to execution, to perform real-time contemporaneous capture of biometric data of the user.

4. The one or more non-transitory computer-readable media of claim 3, wherein capture of biometric data of the user comprises capture of biometric data from a an image of the user.

5. The one or more non-transitory computer-readable media of claim 4, wherein the image comprises the user's face, and wherein capture of biometric data from an image of the user comprises capture of facial data from the image.

6. The one or more non-transitory computer-readable media of claim 3, wherein capture of biometric data of the user comprises capture of fingerprint data from the user.

7. The one or more non-transitory computer-readable media of claim 1, wherein the decryption and encryption keys form a private/public key pair.

8. (canceled)

9. The one or more non-transitory computer-readable media of claim 2, wherein decrypt the media file comprises:
decrypt metadata associated with the encrypted media file using the decryption key; and
decrypt media data from the media file based at least in part on the decrypted metadata.

10. The one or more non-transitory computer-readable media of claim 9, wherein:
decrypt metadata comprises decrypt a symmetric media encryption key; and
decrypt media data comprises decrypt media data using the symmetric media encryption key.

11. The one or more non-transitory computer-readable media of claim 10, wherein:
the metadata associated with the encrypted media file comprises a first encrypted symmetric media encryption key encrypted with the encryption key generated based on previously provided biometric data of the user; and
the media file further comprises one or more other encrypted symmetric media encryption keys that are respectively encrypted with encryption keys generated based on previously provided biometric data of other users.

12. The one or more non-transitory computer-readable media of claim 9, wherein:
the decrypted metadata comprises an access policy associated with the user; and
decrypt media data comprises selectively allow access to media data based at least in part on the access policy associated with the user.

13. An apparatus for decrypting an encrypted media file, the apparatus comprising:
one or more computer processors; and
a decryption key generation component configured to be operated by the one or more computer processors to:
receive a request for a decryption key to decrypt an encrypted media file, wherein the request is generated in response to a user's request to access the encrypted media file, and wherein the media file is encrypted using a public key of a public-private key pair generated based on previously provided biometric data of the user;
generate, in response to the request, a decryption key based at least in part on real-time contemporaneously captured biometric data of the user, wherein data about the private key of the public private key pair is not available to the computing device; and
provide the decryption key for use to decrypt the encrypted media file.

14. The apparatus of claim 13, further comprising a media decryption component configured to be operated by the one or more computer processors to decrypt the encrypted media file using the provided decryption key.

15. The apparatus of claim 13, wherein the decryption key and encryption key form a private/public key pair.

16. The apparatus of claim 13, further comprising a biometric data capture component configured to capture biometric data of the user.

17. The apparatus of claim 16, wherein the biometric data capture component comprises an image capture component.

18. The apparatus of claim 17, wherein the image capture component is configured to be operated to capture biometric data from an image of the user's face.

19. The apparatus of claim 16, wherein the biometric data capture component comprises a fingerprint capture component.

20. One or more non-transitory computer-readable media comprising instructions stored thereon that are configured to cause a computing device, in response to execution of the instructions by the computing device, to:
obtain an encryption key generated based on previously provided biometric data of a user, wherein the encryption key is a public key of a public-private key pair;
encrypt the media file to produce an encrypted media file such that the encrypted media file may be decrypted using a decryption key generated based on contemporaneously captured biometric data of the user, wherein data about the private key of the public-private key pair is not available to decrypt the encrypted media file; and
provision the encrypted media file to be accessed by the user.

21. (canceled)

22. The one or more non-transitory computer-readable media of claim 20, wherein encrypt the media file comprises:
encrypt media data using a symmetric media encryption key;
encrypt the symmetric media encryption key using the public key; and
include the encrypted symmetric media encryption key in the encrypted media file.

23. The one or more non-transitory computer-readable media of claim 20 wherein:
the public key comprises a first public key;
the encrypted symmetric media encryption key comprises a first encrypted symmetric media encryption key; and
encrypt the media file further comprises:
encrypt the symmetric media encryption key using a second public key generated based on previously provided biometric data of an other user to produce a second encrypted symmetric media encryption key; and
include the second encrypted symmetric media encryption key in the encrypted media file.

24. The one or more non-transitory computer-readable media of claim 20, wherein encrypt the media file comprises:
encrypt an access policy associated with the user using the public key; and
include the access policy associated with the user in the encrypted media file.

25. The one or more non-transitory computer-readable media of claim 20, wherein provision the media file to be accessed by the user comprises provision the media file to be accessed on a media sharing service.

26. The one or more non-transitory computer-readable media of claim 20, wherein provision the media file to be accessed by the user comprises transmit the media file to the user.

27. An apparatus for decrypting an encrypted media file, the apparatus comprising:
one or more computer processors; and
a media encryption component configured to be operated by the one or more computer processors to:
obtain an encryption key generated based on previously provided biometric data of a user, wherein the encryption key is a public key of a public-private key pair;
encrypt the media file to produce an encrypted media file such that the encrypted media file may be decrypted using a decryption key generated based on contemporaneously captured biometric data of the user, wherein data about the private key of the public-private key pair is not available to decrypt the encrypted media file; and
provision the encrypted media file to be accessed by the user.

28. The apparatus of claim 27, wherein encrypt the media file comprises:
encrypt the media data using a symmetric media encryption key;
encrypt the symmetric media encryption key using the public; and
include the encrypted symmetric media encryption key in the encrypted media file.

29. The apparatus of claim 27, wherein encrypt the media file comprises:
encrypt an access policy associated with the user using the public; and
include the access policy associated with the user in the encrypted media file.

30. The apparatus of claim 27, wherein obtain an encryption key comprises obtain an encryption key from a key maintenance component.
